(19) United States
(12) Patent Application Publication
(10) Pub. No.: US 2008/0199139 A1
(43) Pub. Date: Aug. 21, 2008

(54) Storage Device for Use in Fiber Optic Communication Systems and Method of Using the Same

(75) Inventor: Craig Henderson, Woodruff, SC (US)

Correspondence Address: SUGHRUE MION, PLLC, 2100 PENNSYLVANIA AVENUE, N.W., SUITE 800, WASHINGTON, DC, 20037, US

(73) Assignee: AFL TELECOMMUNICATIONS LLC, Spartanburg, SC (US)

(21) Appl. No.: 11/915,550

(22) PCT Filed: Jul. 31, 2006
(86) PCT No.: PCT/US2006/029650

§ 371 Date: Nov. 26, 2007

Related U.S. Application Data
(60) Provisional application No. 60/703,504, filed on Jul. 29, 2005.

(51) Int. Cl. G02B 6/00

(52) U.S. Cl. 385/135

(57) ABSTRACT

A storage device for storing cable or fiber, rotating element, and method of using the same are provided. The storage device includes a housing, having an inner cavity and at least one opening; and a rotating element which is rotatably and removably placed within the inner cavity and has at least one receptacle. The rotating element includes a base member; a receptacle for holding at least one splice sleeve containing a sliced fiber; and a plurality of guide ridges, which are disposed on the base member, one of the plurality of guide ridges disposed at either end of each of the at least one receptacle. The method includes placing the fiber or cable into the receptacle; draping excess fiber or cable through guide fins; and rotating the rotating element to retract or dispense the excess fiber or cable into or out of the storage device through the at least one opening in the housing.

### CROSS-REFERENCE TO RELATED APPLICATION

This application claims the benefit of priority from U.S. Provisional Patent Application No. 60/703,504, filed in the U.S. Patent and Trademark Office on Jul. 29, 2005, the disclosure of which is incorporated herein by reference in its entirety.

### BACKGROUND OF THE INVENTION

1. Field of the Invention

Devices and methods consistent with the present invention relate to the storage of fibers in fiber optic communication systems, and more particularly, to the storage of excess fiber optic cable or ribbons in a fiber optic communication system.

2. Description of the Related Art

As the number of fibers deployed in fiber optic communication systems has increased, the management of fibers has become exceedingly complex. In splicing fibers, terminating fibers, and connecting fibers, each fiber typically has excess length which must be addressed. As the number of fibers increases, this excess length multiplies, causing problems in management of the excess lengths of fibers and cables in splice enclosures, fiber distribution frames, cross-connects, multi-fiber installations, FTTX drops, and optical devices and photonic assemblies.

A splice enclosure is generally used to house splices after a splicing operation is performed. In slicing two fibers together, typically two to four feet of excess fiber length is needed on either side of the splice point to permit easy placement of the fiber ends into a splicing apparatus and to permit easy re-termination if required. In some cases, the fiber cables being spliced together contain 864 fibers or more, in either a stranded or ribbon configuration. However, even for lower fiber count cable splicing, the storage of the excess fiber can present significant difficulties for the operator and for the design of a splice enclosure which holds the splices.

A fiber optic storage enclosure manages the excess slack fiber using a number of different techniques. First, excess slack may be stored into a single area (e.g., a “storage basket”). Second, excess fiber may be stored on “splice trays” which typically contain one or more spliced fiber pairs or spliced ribbons. Third, some combination of storage techniques may be used, for example, storage in the storage basket and also in the splice tray. No matter which technique is used to store the excess fiber, it is incumbent upon the operator to route and wrap the excess fiber length on the splice tray by hand without entangling the fibers, and/or to pull the excess fiber down into the storage basket. This storage procedure is tedious and requires a great amount of effort and skill by the operator. More importantly, however, if the radius of a loop or coil of fiber is less than the bending radius of the fiber, excess bending losses will occur during the transmission of information through the fibers. Moreover, existing storage procedures have a risk of breaking or damaging the fibers, a risk which only increases as the number of fibers to be stored increases.

After the excess fiber is stored, a different problem occurs in that the operator must often return to the splice storage enclosure in order to re-route fibers, to splice additional fibers, to repair or replace existing fibers, to add additional branch cables or to splice previously un-terminated fibers. In each of these cases, re-entry is complicated and time consuming. Often, fibers are broken as the operator attempts to disentangle the slack fiber, to identify the correct fiber on which to work, or to move the slack fiber out of the way to permit access to the fibers to be spliced. Thus, even if the initial storage of excess fiber within the storage enclosure is done properly, the situation within the enclosure tends to degrade with each re-entry to the splice enclosure.

Moreover, the operations involving storage of excess fiber all depend on the skill and attention to detail of the operator, and such operations are very common as new customers or services are added to the fiber optic network.

Management of excess cable of jumper cables used in fiber distribution frames and cross-connect cabinets presents similar problems. Jumper cables are typically manufactured to certain set lengths (e.g., five meters or ten meters, etc.). These set lengths are frequently longer than required to connect from one distribution frame to another. The excess jumper length becomes unmanageable, especially as the number of jumper cables increases. These jumper cables frequently hang down and tangle together, and thus present problems of proper identification, management, and reconfiguration for the operator, problems which are similar to those present in the storage enclosure described above.

A multi-fiber cable installation also presents similar problems with provisioning slack loops of cable. In such installations, it is often desirable to provision slack loops so additional cable length is available for future system branching or reconfiguration, to provide sufficient slack for splicing when a cable has been inadvertently broken, or for reconfiguration when something in the physical environment changes, such as building construction or reconstruction, necessary relocation of a telephone pole, etc.

In multi-fiber cable installations, two methods are commonly used for storing excess cable. One method is to manually coil a length of cable, which is then hung from a pole in an aerial cable deployment or from a rack or wall bracket in a cable vault or an underground cable run. However, this method suffers from the problem that the resulting coil is user dependent, and often introduces a twist into the cable. This twist must be corrected in order to access the slack or to re-coil an excess length that remains after subsequent operations. Moreover, the coil must be hung and re-hung, which is time consuming, and in the case of underground cables or cable storage in a vault, space imitations make storage of such loops difficult.

The second method for storing cable in a multi-fiber cable installation is the use of a “snow shoe”. In the snow shoe configuration, the cable enters through a narrow inlet and is then wrapped in a loop and returns out the narrow inlet, like a snow shoe. While the snow shoe method provides a much neater and ascetically pleasing slack installation, it has limited slack length capacity.

Management of excess lengths of FTTX drop cables produces similar difficulties for the operator. In FTTX deployments, drop cables that extend from the terminal to a NID on the side of the customer premises leave excess lengths of the drop cable. In such situations, it is desirable to use drop cables that are pre-terminated with a connector at each end, similar to the case of a jumper cable, in order to speed up drop cable installation by a simple plug-in drop installation. However, these pre-terminated cables require the use of set cable lengths that have excess length. Moreover, many drop cables have a non-circular (e.g., flat or nearly rectangular) cross section, which magnifies the problems with coiling excess cable length by hand. In addition, a coil of such a non-circular, flat cable may be subject to severe wind loading, placing excess stress on the attachment of the coil wherever it is located.

Many similar problems arise in the management of excess fiber length within optical assemblies and fiber optic test equipment. Many optical devices and photonic assemblies, such as lasers, couplers. etc., require splices and storage of the resulting excess fiber length attached to the optical devices. In such cases, there are several levels of subassembly during the manufacturing process, and the numbers of splices to be stored is thus substantial, for example sometimes exceeding 100 splices for a complex EDFA, for a MUX/DFMUX device, or for a WDM/splitter assembly. Such subassemblies present problems similar to those described above. An operator must carefully wind each spliced fiber into a “racetrack”, i.e., hand-generated storage loop, inside the optical assembly housing. Such operations rely upon the skill and diligence of the operator. The operator must therefore also possess the required training so as not to break or damage the fiber. An additional problem with this type of manufacturing method is that a precise length of fiber is required on each side of the splice point in order to ensure that the operator can wind a specific number of wraps around the slack fiber “racetrack”. If the fiber becomes too short due to the need to re-cleave, i.e., splice a second time, the fiber must be cut back on each side just enough to result in a total fiber length that provides one less wrap of the fiber around the circumference of the “racetrack”. As with the above storage situations, it is easy for fibers to become entangled either during assembly, or during any functional test and subsequent rework.

### SUMMARY OF THE INVENTION

Exemplary embodiments of the present invention overcome the above disadvantages and other disadvantages not described above. However, the present invention is not required to overcome the disadvantages described above, and an exemplary embodiment of the present invention may not overcome any of the problems described above.

According to an aspect of the present invention, there is provided a storage device for storing fiber or cable, the storage device including a housing, having an inner cavity and at least one opening between the inner cavity and the exterior of the housing; and a rotating element which is rotatably and removably placed within the inner cavity of the housing and has at least one receptacle for holding the cable or fiber.

According to another aspect of the present invention, there is provided a rotating element for use in a splice storage device, the rotating element including a base member; at least one receptacle, which is disposed in a center area of the base member, for holding at least one splice sleeve containing a spliced fiber; and a plurality of guide ridges, which are disposed on the base member, one of the plurality of guide ridges disposed at either end of each of the at least one receptacle.

According to another aspect of the present invention, there is provided a method of storing a fiber or cable in a storage device including a housing, having an inner cavity and at least one opening between the inner cavity and the exterior of the housing, and a rotating element which is removably and rotatably placed within the inner cavity and has at least one receptacle for holding the cable or fiber, wherein a plurality of guide fins are formed on the rotating element at either end of the at least one receptacle, such that a corresponding two of the guide fins on either side of the at least one receptacle guide the fiber or cable held in the at least one receptacle as the rotating element is rotated, the method including placing the fiber or cable into the at least one receptacle; draping excess fiber or cable through the guide fins on either end of the at least one receptacle; and rotating the rotating element to retractor dispense the excess fiber or cable into or out of the storage device through the at least one opening in the housing.

### BRIEF DESCRIPTION OF THE DRAWINGS

The above and other aspects of the present invention will be more apparent from the following detailed description taken in conjunction with the accompanying drawings, in which:

FIG. 1 is an exemplary view illustrating a storage device according to an exemplary embodiment of the present invention;

FIG. 2 is an exemplary view illustrating bottom features of a rotating element of the storage device of FIG. 1;

FIG. 3 is an exemplary view illustrating an exploded view of the storage device of FIG. 1 showing a cover;

FIG. 4 is a top view of the storage device of FIG. 1;

FIG. 5 is a side view taken along the sectional line of FIG. 4;

FIG. 6 is a detail view of a feature of a cover of the storage device shown in FIG. 5;

FIG. 7 is a detail view of a mechanism of the storage device shown in FIG. 5;

FIG. 8 is a side view of a storage device of FIG. 3;

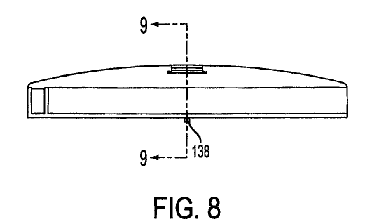

FIG. 9 is a side view taken along a sectional line of FIG. 8;

FIG. 10 is a detail view of a feature of FIG. 9;

FIG. 11 is a detail view of another feature shown in FIG. 9;

FIG. 12 is a top view of the storage device of FIG. 1 showing a fiber or cable stored within the storage device;

FIG. 13 is a side view of the storage device of FIG. 3 showing stacking features of the storage device;

FIG. 14 is a side view showing two storage devices of FIG. 1 stacked together;

FIG. 15 is an exemplary view illustrating a storage device according to another exemplary embodiment of the present invention; and

FIG. 16 is an exemplary view illustrating an exploded view of the storage device of FIG. 15 showing a cover;

FIG. 17 is a top view of the storage device of FIG. 16; and

FIG. 18 is a perspective view of the storage device of FIG. 16.

### DETAILED DESCRIPTION OF EXEMPLARY EMBODIMENTS OF THE PRESENT INVENTION

Hereinafter, exemplary embodiments of the present invention will be described in detail with reference to the accompanying drawings. However, the present invention is not limited to the exemplary embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the whole description of the present invention, the same drawing reference numerals are used for the same elements across various figures.

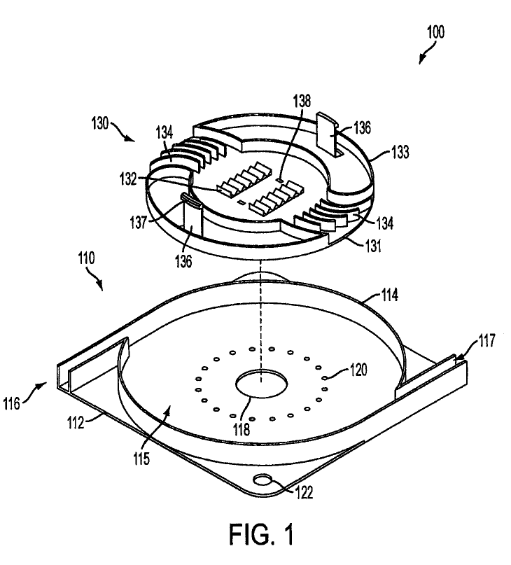

Turning now to FIG. 1, shown is a storage device 100 according to an exemplary embodiment of the present invention. The storage device 100 may be a storage tray or a splice storage tray. Storage device 100 includes a housing 110 and a rotating element 130. The housing 110 includes a housing base 112 with housing walls 114 formed thereon to form an inner cavity 115 on the housing base 112. The inner cavity 115 is approximately circular. The housing base 112 is square shaped. However, other geometries are contemplated, for example housing base 112 may also be rectangular, circular, or octagonal, etc. Housing walls 114 also form openings 116, 117 on opposite corners of housing base 112 to accommodate the ingress and egress of a fiber or a cable into the circular cavity 115. A center hole 118 is formed in the center of the circular cavity 115 of the housing base 112. A plurality of receiving holes 120 are also formed in the circular cavity 115 of the housing base 112. The plurality of receiving holes 120 are evenly spaced in the form of a circle, the radius of which is located between the radius of the center hole 118 and the radius of the interior of the circular cavity 115. Alternatively, the plurality of receiving holes 120 may be indentations which do not go all the way through the housing base 112, and the plurality of receiving holes 120 may be non-uniformly spaced. At least one guide hole 122 is provided in the housing base 112 outside of the circular cavity formed by the housing walls 114.

Rotating element 130 includes a rotating element base 131 which is disc-shaped and is of a diameter smaller than the circular cavity 115. In two columns in a center area of the rotating element base 131, a plurality of receptacles 132 are formed, such that rows of the plurality of receptacles of each column are parallel to each other. The two columns of receptacles are spaced apart such that the first receptacles of the first and second column may accommodate respective ends of a splice sleeve to be stored. Alternatively, the plurality of receptacles may be formed in only one column in the center area of the rotating element base 131, such that each receptacle of the plurality of receptacles 132 may accommodate a whole length of a splice sleeve to be stored. In the present exemplary embodiment, the receptacles are grooves formed in an elastomer such that the walls of the receptacles hold a splice sleeve securely. However, it is contemplated that the receptacles may also be hooks or clasps or other similar holders for splice sleeves known in the art. As another example, the center area of the rotating element base 131 that contains the receptacles may also have a hinged cover which snaps into place and would hold the splice sleeves in place. Moreover, other materials are also contemplated for the receptacles 132 as long as the materials allow the fiber or cable to be held securely without damage to the fiber or cable.

A plurality of guide fins 134 are formed on two sides of the plurality of receptacles 132, such that a guide fin on each of the opposite sides of the receptacles corresponds to and is aligned with each respective row of the receptacles 132. The interior edge of the guide fins on either side of the row of receptacles is aligned with the respective row of receptacles, and the exterior edge of each guide fin is arced toward the edge of the rotating element base 131. The curve of the arc of the guide fins is located on a counterclockwise side of the guide fins 134 as the rotating element 130 is turned clockwise. The guide fins 134 are staggered, gradually increasing in length with the length of the guide fin 134 facing the clockwise direction of rotation of the rotating element 130 being shortest and the length of the counterclockwise-most guide fin being longest. An exterior edge of the counterclockwise-most guide fin runs to the edge of the rotating element base 131. The radius of curvature of the guide fins 134 is set based on the bending radius of the fiber being used, and the radius of curvature of the guide fins 134 is tangent to the radius of rotation of the rotating element 130. Along the remainder of the circumference of the rotating element base 131, i.e., where the guide fins 134 are not located, rotating element walls 133 are formed. The rotating element walls are perpendicular to the rotating element base 131 and an exterior of the rotating element walls 133 is flush with the exterior edge of the rotating element base 131.

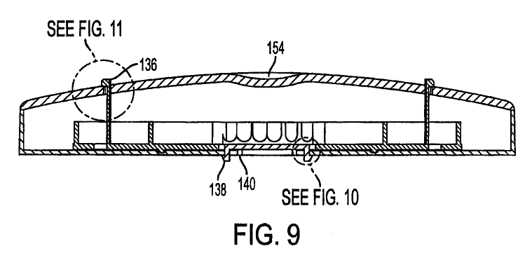

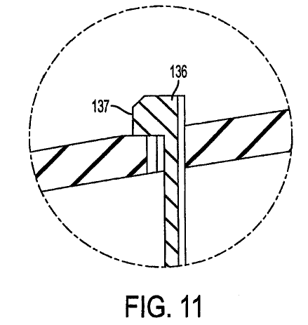

Two finger tabs 136 are disposed on the rotating element base 131, one above and one below the columns of receptacles 132. The finger tabs 136 extend perpendicular to the rotating element base 131. Each of the finger tabs 136 has a finger tab lip 137, as shown in FIGS. 9 and 11. The finger tab lip 137 extends away from the center of the rotating element 130.

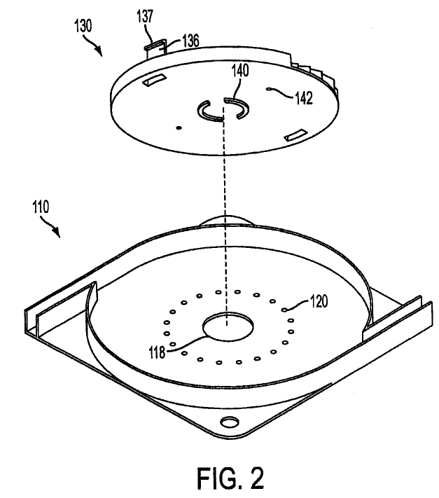

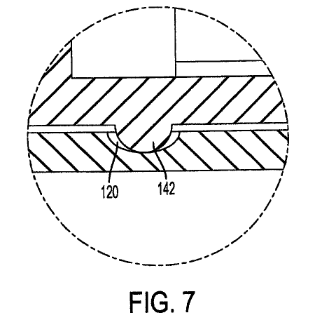

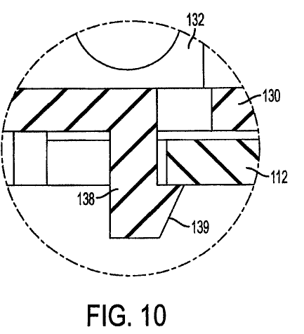

Referring to FIG. 2, shown is a bottom side of the rotating element 130. On the bottom of rotating element 130 are disposed semi-circular ridges 140, the outer circumference of which fits within an inner circumference of the center hole 118 of housing base 112. Two protrusions 142 are disposed on a bottom surface of the rotating element base 131, and protrude from the bottom surface. Each of the protrusions 142 is slightly smaller than a corresponding receiving hole of the plurality of receiving holes 120, as shown in FIG. 7. In FIG. 7, the protrusion 142 is advantageously semi-spherical. However, other geometries are possible. The position of the protrusions 142 corresponds to the position of the plurality of receiving holes 120 in the housing base 112. At least two bottom tabs 138 (not shown in FIG. 2) are disposed on the bottom of the rotating element 130, as best shown in FIGS. 9 and 10. Each bottom tab 138 has a bottom tab lip 139 extending in a direction away from the center of the rotating element 130.

A splice sleeve containing a splice of a fiber is placed into one of the receptacles 132 in the center area of the rotating element 130. Lengths of the fiber or cable are then run across the guide fins 134 which correspond to the receptacle 132. Alternatively, a section of fiber or cable may be placed into one of the receptacles.

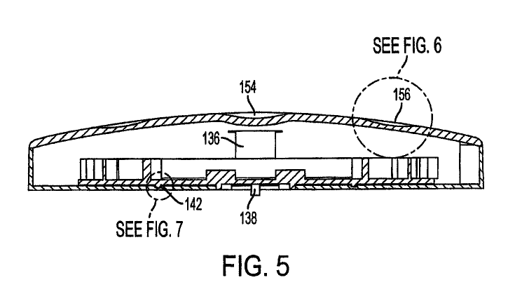

Once the fiber or cable is placed in the receptacle 132 and run across the guide fins 134, the rotating element is placed into the center cavity of housing 110. Semi-circular ridges 140 and bottom tabs 138 on the bottom of the rotating element 130 are aligned with an inner circumference of the center hole 118 of housing 110, and thus guide the placement of the rotating element 130 into the housing 110. The protrusions 142 in the bottom of the rotating element 130 sit into the plurality of receiving holes 120 in the housing base 112, as illustrated in FIGS. 5 and 7.

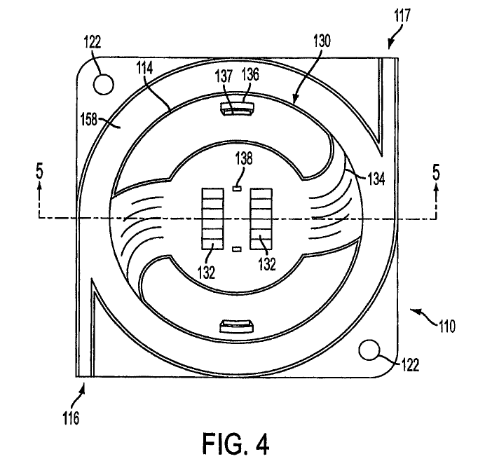

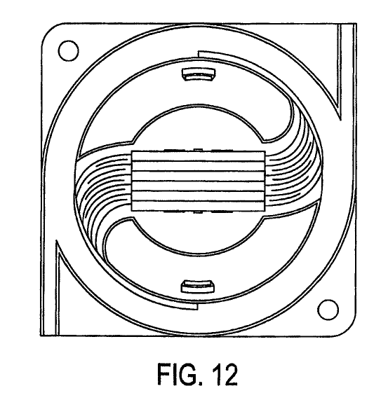

The ends of the fiber or cable leading away from the splice are draped through the openings 116, 117 formed by the housing walls 114 of the housing 110 and out of the housing 110. Rotating element 130 is then pressed against the housing 110 such that the bottom tab lips 139 of the bottom tabs 138 snap over the edges of center hole 118 of housing 110. The bottom tab lips 139 of the bottom tabs 138 thus hold the rotating element 130 in the housing 110, while allowing the rotating element 130 to rotate within the housing 110. To remove the rotating element 130 from the housing 110 again, slight inward pressure is applied to the bottom tab lips 139 of the bottom tabs 138 of the rotating element 130 until the bottom tab lips 139 clear the center hole 118 of the housing 110, and the rotating element 130 is removed. FIGS. 4 and 12 show views of the rotating element 130 placed into the housing 110, both without and with stored fiber, respectively.

Once the rotating element 130 is secured into the housing 110, one of the finger tabs 136 which extend up at a side of the rotating element 130 is grasped and the finger tab 136 is used to turn the rotating element 130 within the housing 110. The rotating element 130 is turned clockwise in the housing 110 to retract the fiber or cable into the storage cavity 158 formed between the diameter of the rotating element 130 and the housing walls 114 of the housing 110. FIG. 12 shows a view of the storage tray 100 having a fiber cable stored in the storage cavity 158. The rotating element 130 is turned counterclockwise in the housing 110 to dispense the fiber or cable from the storage cavity 158 out through the openings 116 and 117. However, one skilled in the art will understand that the guide fins 134 of the rotating element 130 and the openings 116, 117 of the housing 110 may be mirrored to allow dispensing of the fiber by turning the rotating element clockwise, and to allow retracting the fiber or cable by turning the rotating elements counterclockwise.

As the rotating element 130 is turned in the housing 110, the guide fins 134 help support the fiber or cable when the rotating element is turned so that damage to the fiber or cable is prevented. The guide fins 134 also help the fiber or cable to maintain a given bending radius while the rotating element 130 is turned to dispense and retract the fiber or cable and while the fiber or cable is stored in the storage device 100. Maintaining the bending radius prevents a bending loss from occurring in the cable or fiber which is stored in the storage device 100. The staggered feature of the guide fins allows the rotating element 130 to be turned more easily and prevents kinks in the fiber or cable in the case where excess fiber or cable from more than one fiber or cable is stored in the storage device 100. Alternatively, one skilled in the art will understand that the guide fins may also be ridges or pegs or the like.

As the rotating element 130 is turned, the protrusions 142 slide from the receiving holes 120 in which the protrusions 142 initially sit to the next receiving hole in the direction of turning. Each protrusion 142 thus moves form receiving hole to receiving hole as the rotating element 130 is turned. The protrusions 142 and receiving holes 120 act as a counter force to the rotation of the rotating element 130, and prevent the rotating element 130, and thus the fiber or cable stored in the storage tray 100, from automatically unwinding. In other words, the protrusion 142 and receiving holes 120 act as a type of locking or ratcheting mechanism.

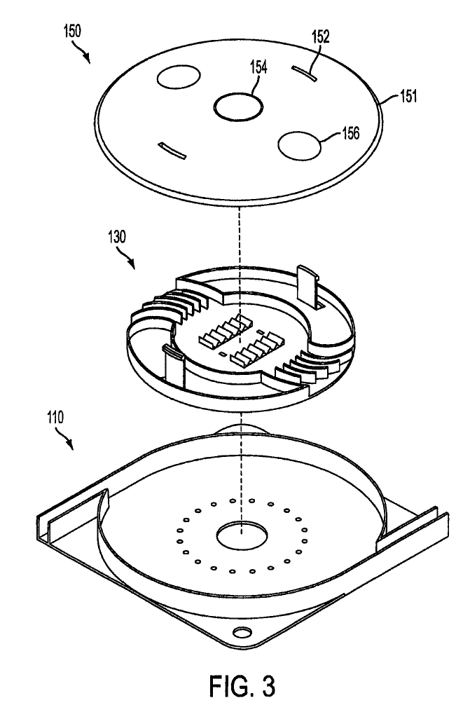

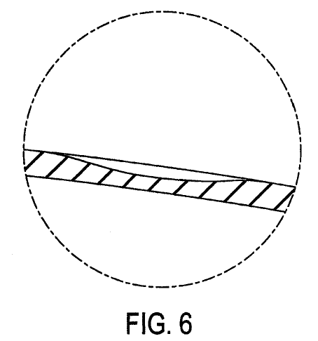

Turning now to FIG. 3, the storage device 100 of FIG. 1 is shown with an optional cover 150. Cover 150 is approximately circular with a diameter corresponding to a diameter of the circular cavity 115 of the housing 110. The cover 150 has a slight arc as is shown in FIG. 5. Two indentations 156 are formed in the top of the cover 150 between the center of the cover 150 and an outer rim 151 of the cover 150. However, alternatively, only one indentation may be provided, or multiple indentations may be provided. The indentations are shown in the figure as circular. However, other geometries would work equally well. Moreover, the indentation or indentations may also be a knob or knobs that an operator could grasp, or holes through the cover such that an operator could place a finger through the hole and turn the rotating element 130. A detail view of the indentation 156 is shown in FIGS. 5 and 6. As can be seen from the detail view of the indentation 156 in FIGS. 5 and 6, the cover 150 is a bit thinner in the area of the indentation 156. However, it is alternatively possible to maintain constant thickness of the cover 150 in the area in which the indentation 156 is formed. A center indentation 154 is formed in the center of the cover 150, as is shown in FIG. 5.

Returning to FIG. 3, two slots 152 are formed in the top of the cover and corresponds to the position of the at least one finger tab 136 disposed on rotating element 130. A detail view of the finger tab 136 is shown in FIGS. 9 and 11. As best shown by FIG. 11, the finger tab 136 includes a finger tab lip 137.

Returning again to FIG. 3, once a fiber or cable is placed in the rotating element 130 and the rotating element 130 is placed and secured in the housing 110 as described above, the cover 150 is placed on the resulting assembly comprising the rotating element 130 and housing 110. The slots 152 of the cover 150 are aligned with the finger tabs 136 formed on the rotating element, and the cover 150 pressed down onto the housing 110 such that the finger tabs 136 project through the slots 152 in the cover 150. The finger tab lips 137 of the finger tabs 136 project through the slots 152 such that the finger tab lips 137 overlap the cover 150 and snap into place. The finger tabs 136 and finger tab lips 137 thus act to secure the cover 150 to the housing 110 to cover the rotating element 130. With the cover 150 thus secured in place, one of the indentations 156 in the cover 150 is then used as a finger well to turn the cover 150, and in turn the housing 110 and the rotating element 130 within the housing 110 in order to dispense and retract the fiber or cable from the storage tray 100. In other words, the cover 150 is turned using one of the indentations 156, and this movement in turn catches the corresponding finger tab 136 extending through a respective one of the slots 152 in the cover 150, causing the finger tab 136 to move as well and to thus rotate the rotating element 130 within the housing 110. To remove the cover 150 from the housing 110, slight pressure is applied in the area of the indentations 156 while the finger tabs 136 are pressed towards the center of the cover 150. The slight pressure combined with the pressure on the finger tabs 136 allows the finger tab lips 137 to pass back through the slots 152 so that the cover 150 may be removed.

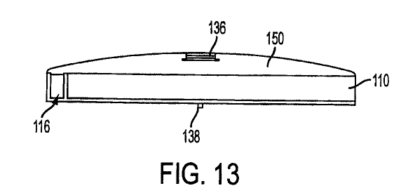

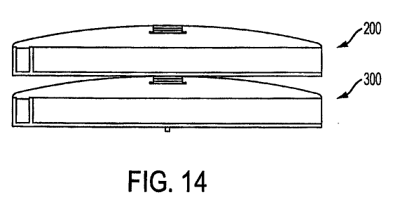

Referring now to FIG. 13, shown is a side view showing the storage device 100 of FIG. 3. Bottom tabs 138 extend down below the bottom of the housing base 112 of the housing 110. Opening 116 allows a fiber or cable to enter or exit the storage device 100, and finger tab 136 extends through the slot in cover 150. FIG. 14 shows a first storage device 200 and a second storage device 300 in a stacked configuration.

Referring to FIGS. 3, 13 and 14, to stack two or more storage devices, the bottom tabs 138 which extend from the bottom of the housing base 112 of a first storage device 200 are placed into the center indentation 154 in the cover 150 of a second storage device 300. The bottom tabs 138 of the first storage device 200 act to secure the first storage device 200 to the second storage device 300. Moreover, a guide post (not shown) may be provided and slipped through the guide holes 122 formed in the housing base 112 of the housing 110 of each storage device 200, 300. The guide post and guide holes 122 allow for the storage devices 200, 300 to be stacked one on top of the other, as shown in FIG. 14, or to be hung on the guide post. Using either method, multiple storage devices may be stacked or hung side by side to provide easy storage and manipulation of the storage trays, for example, within a storage enclosure, fiber distribution frame, cross-connect, optical assembly or piece of test equipment, or other suitable area.

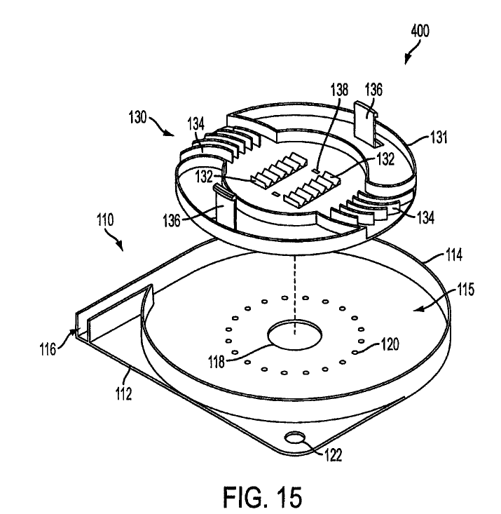

FIGS. 15-18 show a storage device according to another exemplary embodiment of the present invention. Referring to FIG. 15, shown is a storage device according to another exemplary embodiment of the present invention. Storage device 400 according to this exemplary embodiment of the present invention includes a housing 110 and a rotating element 130. Since the features of the rotating element 130 are the same as described above, a repeated description will be omitted.

As in the previous exemplary embodiment, housing 110 includes a housing base 112 with housing walls 114 formed thereon to form an inner cavity 115 on the housing base 112. A center hole 118 is formed in the center of the housing base 112. A plurality of receiving holes 122 are formed in the housing base 112 in a circle surrounding the center hole 118. The plurality of receiving holes 122 may be evenly spaced. A plurality of guide holes 122 are also provided in the housing base 112 outside of the inner cavity 115 formed by the housing walls 114.

However, in the present exemplary embodiment, housing walls 114 only form one opening 116 to accommodate the ingress and egress of a fiber or a cable into the inner cavity 115.

As in the previous exemplary embodiment, a splice sleeve containing a splice of a fiber may be placed into a receptacle 132 at the center of the rotating element 130. Alternatively, a termination end of the fiber or cable or a piece of fiber or cable may be placed into the receptacle 132 at the center of the rotating element 130. Lengths of the fiber or cable are then run across the guide fins 134 which are disposed on either side of the receptacle 132, or in the case of storing a termination end of the fiber or cable the length of the cable may be run across the guide fin 134 on only side. As in the previous exemplary embodiment, the guide fins 134 assist the fiber or cable when the rotating element is turned so that damage to the fiber or cable is prevented. The guide fins 134 also help the fiber or cable to maintain a given bending radius while the rotating element 130 is turned to dispense and retract the fiber or cable. Maintaining the bending radius prevents a bending loss from occurring in the cable or fiber which is stored in the storage device 400. The guide fins may be guide ridges or pegs, etc., as discussed above with respect to the description of the previous exemplary embodiment.

Once the fiber or cable is seated in the receptacle 132 and run across the guide fins 134, the rotating element is placed into the inner cavity 115 of housing 110. Semi-circular ridges 140 and bottom tabs 138 on the bottom of the rotating element 130 are aligned with an inner circumference of center hole 118 of housing 110, and thus guide the placement of the rotating element 130 into the housing 110. The protrusions 142 in the bottom of the rotating element 130 sits into one of the plurality of receiving holes 120 in the housing base 112, as illustrated in FIGS. 5 and 7.

However, in the present exemplary embodiment, the end or ends of the fiber or cable leading away from the termination end or splice are draped through only the opening 116 formed by the housing walls 114 of the housing 110, and out of the housing 110. Rotating element 130 is then pressed against the housing 110 such that the bottom tab lips 139 of the bottom tabs 138 snap over the edges of center hole 118 of housing 110. The bottom tab lips 139 of the bottom tabs 138 thus hold the rotating element 130 in the housing 110, while allowing the rotating element 130 to rotate within the housing 110. To remove the rotating element 130 from the housing 110 again, slight inward pressure is applied to the bottom tab lips 139 of the bottom tabs 138 of the rotating element 130 until the bottom tab lips 139 clear the center hole 118 of the housing 110, and the rotating element 130 is removed.

Once the rotating element 130 is snapped into the housing 110, one of the finger tabs 136 which extend up at a side of the rotating element 130 is grasped and used to turn the rotating element 130 within the housing 110. The rotating element 130 is turned clockwise in the housing 110 to retract the fiber or cable into the storage cavity 158 formed between the diameter of the rotating element 130 and the housing walls 114 of the housing 110. The rotating element 130 is turned counterclockwise in the housing 110 to dispense the fiber or cable from the storage cavity 158 out through the openings 116 and 117.

As the rotating element 130 is turned in the housing 110 in order to retract or dispense the fiber or cable, the protrusions 142 slide from the receiving hole to receiving hole among the plurality of receiving holes 120 in the housing base 112. The protrusions 142 and receiving holes 120 act as a counter force to the rotation of the rotating element 130, and prevent the rotating element 130, and thus the fiber or cable stored in the storage device 400, from automatically unwinding. In other words, the protrusions 142 and receiving holes 120 act as a type of locking or ratcheting mechanism.

This present exemplary embodiment provides a storage device 400 which is slightly more secure from dirt and other elements since there is only one opening 116.

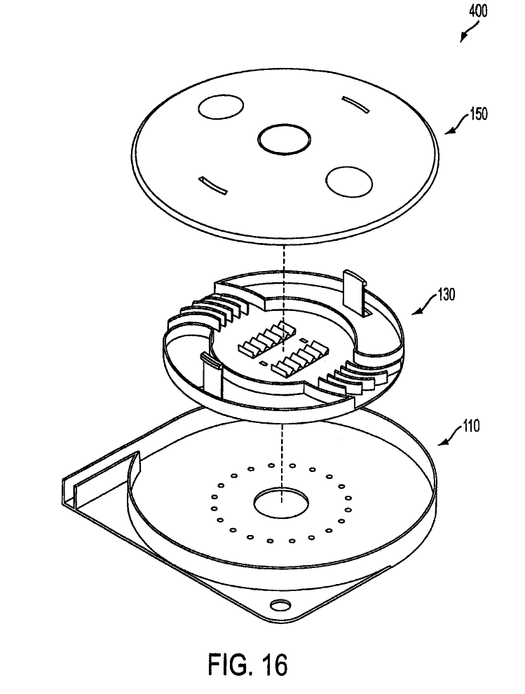

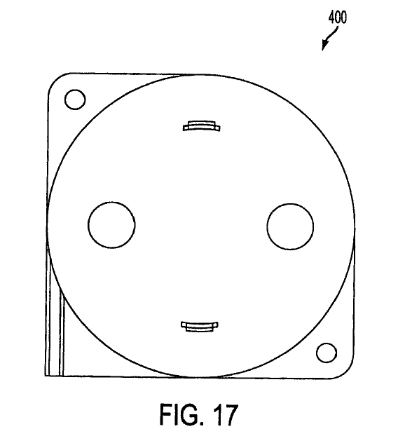

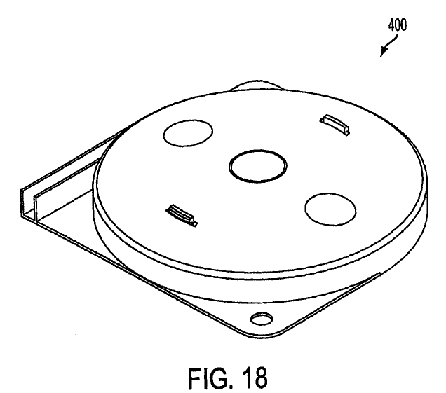

Alternately, the storage device 400 of this exemplary embodiment may also include cover 150, as shown in FIG. 16. The structure and function of the cover 150 in this exemplary embodiment is the same as in the previous exemplary embodiment, and therefore such description is omitted. FIGS. 17 and 18 show top and perspective views of the exemplary embodiment of the present invention shown in FIG. 16.

While exemplary embodiments of the present invention have been described above as having a plurality of receptacles for storing splice sleeves, a storage device is also contemplated which would have only one receptacle 132 in the center of the rotating element base 131. The splice sleeve or cable would then be placed into the receptacle 132 and the lengths of excess fiber or cable run across the guide fins as described above. In such a case, the number of guide fins could be reduced, and more fiber or cable would be able to be stored in the storage cavity of the storage device. Moreover, exemplary embodiments have been described with reference to storing a fiber or cable. However, one skilled in the art will appreciate that the inventive concept applies also to storing ribbon or single strand forms of cable and fiber.

As described above, according to exemplary embodiments of present invention, fiber or cable may be stored easily and securely, and the risk of breaking the fiber or otherwise damaging the fiber or cable is decreased. Exemplary embodiments of the present invention are also easy to use, and require little skill or training on the part of the operator, since the bending radius of the fiber is maintained by the receptacles 132 and guide fins 134 of the rotating element 130.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A storage device for storing cable or fiber, the storage device comprising:
a housing, having an inner cavity and at least one opening between the inner cavity and the exterior of the housing; and
a rotating element which is removably and rotatably placed within the inner cavity of the housing and has at least one receptacle for holding the cable or fiber.

2. The storage device of claim 1, wherein a center hole is formed in the center of the inner cavity of the housing, and wherein at least two bottom tabs are disposed on a bottom surface of the rotating element, the position of the bottom tabs corresponding to an inner circumference of the center hole, and
wherein when the rotating element is placed within the inner cavity, the bottom tabs extend through the center hole and bottom tab lips disposed on the bottom tabs secure the rotating element into the housing such that the rotating element may rotate freely.

3. The storage device of claim 2, wherein the bottom of the rotating element has semi-circular ridges, an outer circumference of which is the same as an inner circumference of the center hole of the inner cavity of the housing, and wherein the semi-circular ridges guide the rotating element in rotating.

4. The storage device of claim 2, wherein at least one finger tab is disposed on the rotating element for use in rotating the rotating element when it is placed in the housing.

5. The storage device of claim 2, wherein at a plurality of finger tabs are disposed on the rotating element for use in rotating the rotating element when it is placed in the housing.

6. The storage device of claim 2, wherein a plurality of receiving holes are formed in a circle in the inner cavity, and at least one protrusion is formed on the bottom surface of the rotating element in a position corresponding to the plurality of receiving holes,
wherein when the rotating element is placed into the inner cavity, the at least one protrusion sits into one of the plurality of receiving holes and provides a counterforce against the rotating of the rotating element.

7. The storage device of claim 1, wherein a plurality of guide fins are formed on the rotating element at either end of the at least one receptacle, such that a corresponding two of the guide fins on either side of the at least one receptacle guide the fiber or cable held in the at least one receptacle as the rotating element is rotated, and
wherein guide fins control the curvature of the fiber or cable.

8. The storage device of claim 7, wherein each of the plurality of guide fins forms an arc, a radius of the arc based on a bending radius of the fiber or cable.

9. The storage device of claim 8, wherein the radius of the arc is tangent to a radius of the rotating element.

10. The storage device of claim 5, further comprising a cover, having a plurality of slots corresponding to the plurality of finger tabs, wherein when the cover is placed onto the housing, having the rotating element placed therein, the plurality of finger tabs of the rotating element extend up through the plurality of slots in the cover and a finger tab lip on each of the plurality of finger tabs secure the cover to the housing.

11. The storage device of claim 10, wherein the cover has at least one finger indentation disposed therein.

12. The storage device of claim 10, wherein the cover has a center indentation.

13. The storage device of claim 12, wherein the bottom tabs of the storage device, having the rotating element placed therein and the cover placed thereon, extend into a center indentation of a second storage device, thus securing the storage device to the second storage device.

14. The storage device of claim 1, wherein the cable or fiber is a ribbon of cable or fiber.

15. The storage device of claim 1, wherein the at least one receptacle holds a splice sleeve containing a splice of the cable or fiber.

16. A storage device for storing cable or fiber, the storage device comprising:
a housing, having an inner cavity and at least one opening between the inner cavity and the exterior of the housing; and
a rotating element which has disposed thereon a means for securely holding the cable or fiber.

17. The storage device of claim 16, further comprising means for rotatably and removably securing the rotating element in the inner cavity of the housing.

18. The storage device of claim 16, further comprising means for guiding the rotation of the rotating element within the inner cavity of the housing.

19. The storage device of claim 16, further comprising means for rotating the rotating element within the housing.

20. The storage device of claim 16, further comprising means for preventing the rotating element from automatically unwinding.

21. The storage device of claim 16, further comprising means for controlling the radius of curvature of the fiber or cable when the rotating element is rotated.

22. A rotating element for use in a splice storage device, the rotating element comprising:
a base member;
at least one receptacle, which is disposed in a center area of the base member, for holding at least one splice sleeve containing a spliced fiber; and
a plurality of guide fins, which are disposed on the base member, one of the plurality of guide fins disposed at either end of each of the at least one receptacle.

23. The storage device of claim 22, wherein each of the plurality of guide fins forms an arc, a radius of the arc based on a bending radius of the spliced fiber.

24. The storage device of claim 23, wherein the radius of the arc is tangent to a radius of the rotating element.

25. A method of storing a fiber or cable in a storage device including a housing, having an inner cavity and at least one opening between the inner cavity and the exterior of the housing, and a rotating element which is removably and rotatably placed within the inner cavity of the housing and has at least one receptacle for holding the cable or fiber, wherein a plurality of guide fins are formed on the rotating element at either end of the at least one receptacle, such that a corresponding two of the guide fins on either side of the at least one receptacle guide the fiber or cable held in the at least one receptacle as the rotating element is rotated, the method comprising:
placing the fiber or cable into the at least one receptacle;
draping excess fiber or cable through the guide fins on either end of the at least one receptacle; and
rotating the rotating element to retract or dispense the excess fiber or cable into or out of the storage device through the at least one opening in the housing.
